(19) United States
(12) Patent Application Publication
(10) Pub. No.: US 2016/0125015 A1
(43) Pub. Date: May 5, 2016

(54) DATABASE DATA DISTRIBUTION MANAGEMENT

(71) Applicant: Microsoft Corporation, Redmond, WA (US)

(72) Inventors: Michael James Zwilling, Bellevue, WA (US); Conor John Cunningham, Austin, TX (US); Joe Cheow Chao Yong, Bellevue, WA (US); Marina Polishchuk, Seattle, WA (US); Brian James Gianforcaro, Seattle, WA (US); Tobias Ternstrom, Redmond, WA (US); Lingzhi Allen, Bothell, WA (US); Nigel Robin Ellis, Redmond, WA (US); Rohan Kumar, Redmond, WA (US); Richard Shawn Bice, Sammamish, WA (US)

(21) Appl. No.: 14/530,390

(22) Filed: Oct. 31, 2014

(51) Int. Cl. G06F 17/30

(52) U.S. Cl. CPC G06F 17/30371; G06F 17/30575

(57) ABSTRACT

The maintaining of a database that is distributed across a front database and one or more cloud databases. Rather than have the front and remote portions of the database be fixed, a data distribution manager evaluates databases segments following a data distribution policy to identify one or more database segments that are to be transferred to or from the one or more cloud databases from or to the front database. In response, the data distribution manager causes the identified database segment to be moved. Accordingly, the data that is in the front database (and the data that is stored in the cloud) may vary over time.

### BACKGROUND

Computing systems and associated networks have revolutionized the way human beings work, play, and communicate. Nearly every aspect of our lives is affected in some way by computing systems. The proliferation of networks has allowed computing systems to share data and communicate thereby vastly increasing information access. For this reason, the present age is often referred to as the “information age”.

Databases are one way to orderly organize often large quantities of data. Furthermore, query processing engines allow for specific queries to be processed against the database, allowing the user to quickly retrieve specific data of interest, even when retrieved from vast quantities of data. In order to process a query, the query processing engine first converts the query into a query plan. Conventionally, databases may be distributed, such that a single query may result in data that comes from portions of the database that are in different locations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the maintaining of a database that is distributed across one or more front databases and one or more cloud databases. For instance, a front database may be a local database or a remote database. Nonetheless, the front database(s) is/are “frontal” in the sense that the query is submitted the front database(s). In fact, those submitting queries to the front database(s) need not even be aware that some of the data may be in the cloud. Rather than have the front and remote portions of the database be fixed, a data distribution manager evaluates databases segments following a data distribution policy to identify one or more database segments that are to be transferred to or from the cloud database(s) from or to the front database(s). In response, the data distribution manager causes the identified database segment to be moved. Accordingly, the data that is in the front database(s) and the data that is stored in the cloud may vary over time.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a database environment in which a distributed database includes frontal database(s) within a computing system, and also includes remote cloud database(s) within a remote cloud system, and in which database segments are moved between the frontal database(s) and the remote cloud database(s);

FIG. 3 illustrates a flowchart of a method for maintaining a database that is distributed across frontal database(s) and remote cloud database(s), and which involve moving database segments between frontal database(s) and remote cloud database(s); and

FIG. 4 illustrates a backup environment for the distributed database.

### DETAILED DESCRIPTION

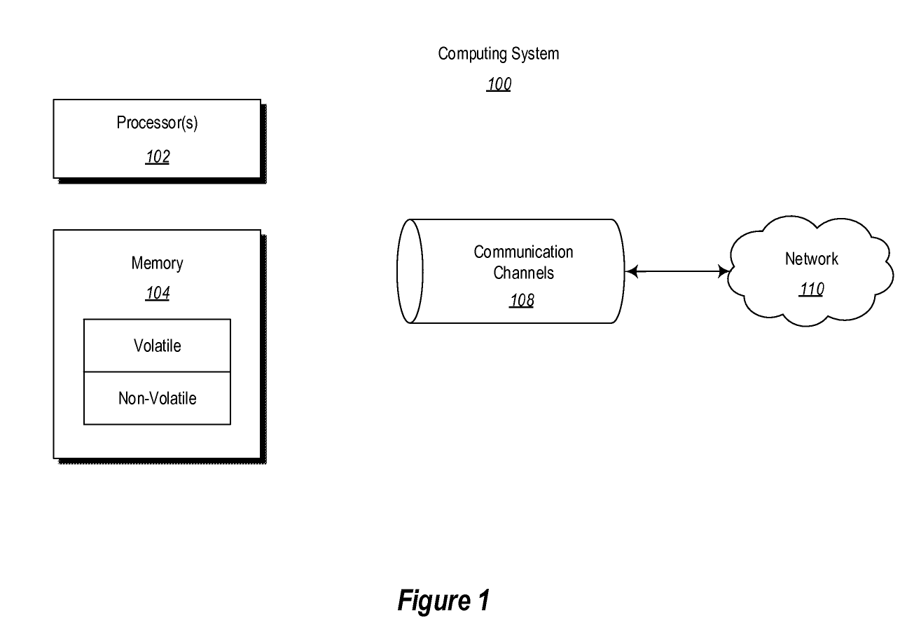

At least some embodiments described herein relate to the maintaining of a database that is distributed across one or more front databases and one or more remote cloud databases. For instance, a front database may be a local database or a remote database. Nonetheless, the front database(s) is/are “frontal” in the sense that the query is submitted the front database(s). In fact, those submitting queries to the front database(s) need not even be aware that some of the data may be in the cloud. Rather than have the front and remote portions of the database be fixed, a data distribution manager evaluates databases segments following a data distribution policy to identify one or more database segments that are to be transferred to or from the cloud database(s) from or to the frontal database(s). In response, the data distribution manager causes the identified database segment to be moved. Accordingly, the data that is in the front database(s) and the data that is stored in the cloud may vary over time. Some introductory discussion of a computing system will be described with respect to FIG. 1. Then, the structure and use of access control will be described with respect to subsequent figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors (of the associated computing system that performs the act) direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110. The computing system 100 also includes a display, which may be used to display visual representations to a user.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

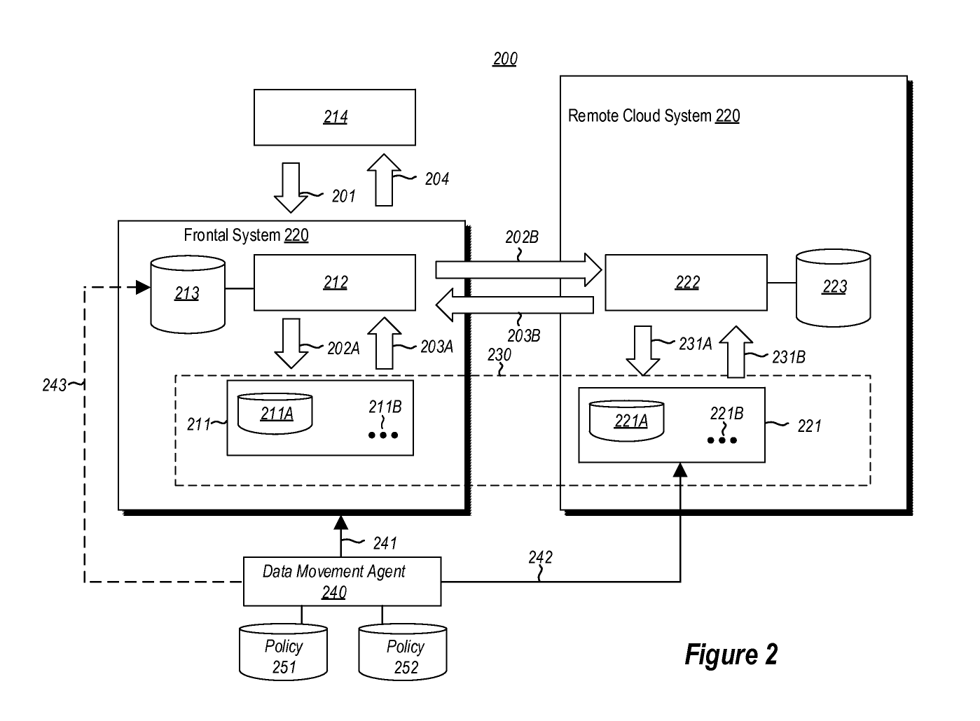

FIG. 2 illustrates a database environment 200 that includes a frontal system 210 and a remote cloud system 220. The frontal system 210 may be, for instance, a computing system and may be structured as described above for the computing system 100 of FIG. 1. The remote cloud system 220 is a cloud computing environment. Cloud computing environments are often referred to as the “cloud” as cloud computing environments offer services that have high availability. From the perspective of a consumer of a cloud service, it is as though the consumer can simply reach up into the cloud at any time and at any place, and retrieve the desired service, without having to worry about the actual physical hardware that supports the service. In many cases, the computational and storage hardware within a datacenter provides the hardware support for a cloud computing environment.

In the illustrated embodiment, the frontal system 210 has one or more front databases 211, and the remote cloud system 220 has one or more remote cloud databases 221. A distributed database 230 is illustrated as including both the front database(s) 211 and the remote cloud database(s) 221. The frontal system 210 is “frontal” in the sense that the frontal system 210 receives queries (e.g., query 201) from a database utilization system 214 (e.g., that includes a software application that submits commands, such as queries, to the database system, such as the frontal system 210) directed at the distributed database 230, and provides corresponding query responses (e.g., query response 204) to the database utilization system 214. In fact, those submitting queries (e.g., the database utilization system 214) to the frontal system 210 need not even be aware that some of the data of the database may be in the cloud. The database utilization system 214 may be local to or remote from the frontal system 210 and may also be a computing system such as that described above with respect to FIG. 1. While the one or more front databases 211 are illustrated as including a single front database 211A, the one or more front databases 211 may include more front databases as represented by the ellipses 211B. Also, while the one or more cloud databases 221 are illustrated as including a single cloud database 221A, the one or more cloud databases 221 may include more cloud databases as represented by the ellipses 221B. One situation in which multiple databases may be utilized is when the underlying database platform has a maximum limit on database size.

The frontal system 210 also includes a query plan generator 212 that receives commands (e.g., command 201) to be processed against the distributed database 230. The commands might include administrative commands issued by an administrator of the distributed database 230, or perhaps programming commands issued by a programmer of the distributed database 230. However, during operation time, the commands are more likely to be queries issued by users of the distributed database 230. For instance, as illustrated, a database utilization system 214 issues a command 201 to the frontal system 210, with the command 201 being received by the query plan generator 212.

In the case of an administrator issuing a command, the database utilization system 214 might have a database utilization application (or an application that utilizes the distributed database 230). In the case of a programmer issuing a command, the database utilization system 214 might have a database software development application. In the case of a run-time user issuing a command, the database utilization system 214 might have an application that submits database queries. However, regardless of the issuer of the command 201, the command 201 itself need not have any special structure to align with the structure of the distributed database 230. Rather, the command 201 may be issued and structured without regard to whether the underlying database is a single database or is distributed throughout the frontal system 210 and the remote cloud system 220.

The query plan generator 212, on the other hand, has knowledge of the presence of the front database(s) 211 and the remote cloud database(s) 221. Furthermore, the query plan generator 212 has access to location data 213, which represents where data resides (e.g., whether on the front database(s) 211 or whether on the remote cloud database(s) 221). Accordingly, the query plan generator 212 has an understanding of how the data is distributed throughout the distributed database 230. The query plan generator 212 uses the location data 213 to formulate and issue a query plan in response to receiving a query (such as query 201 of FIG. 2).

In the case that the query plan generator 212 determines that all of the data to be used to respond to the query 201 is located only on the front database(s) 211, then the query plan is simply submitted to the front database(s) 211. However, in the case in which the query plan generator 212 determines that the data to be used to respond to the query 201 is distributed between the front database(s) 211 and the remote cloud database(s) 221, then the query plan generator 212 sends a portion 202A of the query plan to the front database(s) 211 for processing, and another portion 202B of the query plan to the remote cloud database(s) 221 for processing. Hereinafter, the portions 202A and 202B of the query plan may be collectively referred to as the “query plan 202”.

However, even when the query plan generator 212 finds the location data 213 indicates helpful data to respond to the query resides in the remote cloud database(s) 220, there may be times when the query plan generator 212 nonetheless elects not to issue portion 202B of the query plan 202 to the remote cloud database(s) 221. As an example, perhaps there is not presently an established communication connection between the frontal system 210 and the remote system 220. Alternatively, perhaps the data on the frontal system 210 is sufficient to at least give a partial answer to the query.

In any case, if the portion 202B of the query plan 202 is dispatched, the portion 202B is then sent to the remote cloud system 220. The portion 202B of the query plan 202 is then received by a query plan processor 222 in the remote cloud system 230. The query plan processor 222 submits the appropriate query to the remote cloud database(s) 221 (as represented by arrow 231A) and gathers the results (as represented by arrow 231B). However, far more than simply gathering results of the query, the query plan processor 222 is capable of actually performing computation on data from the remote database(s) to obtain query results. Accordingly, that input data to that computation need not now be downloaded to the frontal system 210. Instead, the computation is performed on the remote cloud system 220. The portion 202B of the query plan 202 designates the computations to be performed. Since the results of computation of the query plan processor 222 are downloaded to the frontal system 210 (as opposed to the potentially much larger input to such computation), the amount of data that is transmitted from the remote cloud system 220 and the frontal system 210 is significantly reduced.

The query plan generator 212 receives results from both the front database(s) 211 (as represented by arrow 203A) as well as the remote cloud database(s) 221 via the query plan processor 222 (as represented by arrow 203B), and aggregates (e.g., through a merge or union) those result to return the final query result (as represented by arrow 204).

In some embodiments, the query may be handled hierarchically for a tiered hierarchy of databases. For instance, suppose that the remote database(s) 221 included multiple databases. In that case, the query plan processor 222 may process the portion 202B of the query plan 202 much as the query plan generator 212 handled the original query 201. Specifically, the query plan processor 222 may generate a query plan based on location data 223 describing how the data is distributed across the remote cloud databases 221. This hierarchical structure may continue recursively for potentially many tiers. Likewise, if the front database(s) 211 includes multiple front databases, a similar query plan processor (not shown) may use location data (not shown) to determine which of the front databases 211 the data is on, and formulate the appropriate query plan against each front database.

However, in accordance with the principles described herein, the distribution of the data across the distributed database 230 changes over time. In particular, a data movement agent 240 (also referred to as herein as a “data movement manager” or a “data distribution manager”) transfers portions of the remote cloud database(s) 221 to the front database(s) 211 (as represented by arrow 241) in response to evaluating policy 251. The data movement agent 240 also transfers portions of the front database(s) 211 to the remote cloud database(s) 221 (as represented by arrow 242) in response to evaluating policy 252. In the case of the front database(s) 211 being local databases, this may be referred to as “remoting” the portion of the front database(s) 211. The data movement agent 240 also updates the location data 213 whenever a transfer occurs (as represented by arrow 243). The data movement agent 240 may be located on the frontal system 210 or may be located in the remote cloud system 220, or distributed therebetween. However, although not required, for security purposes, there may be an inclination to locate the data movement agent 240 on the frontal system 210. In one embodiment, the data movement agent 240 may be implemented as part of the query plan generator 212.

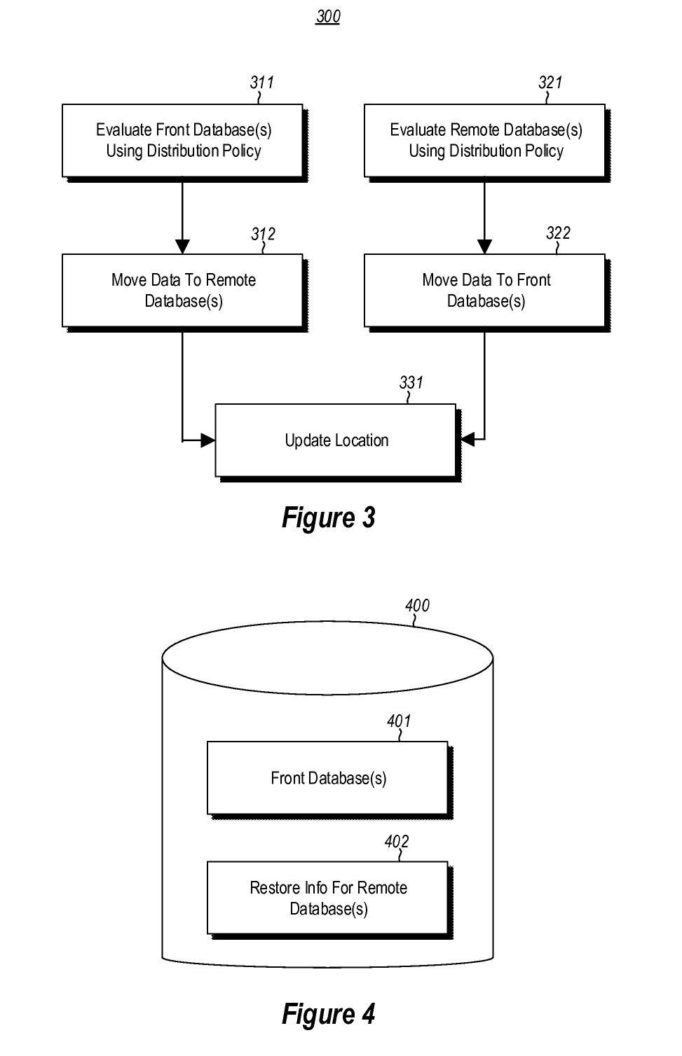

FIG. 3 illustrates a flowchart of a method 300 for maintaining a database that is distributed across front database(s) and remote database(s). The method 300 may be performed by, for instance, the data movement agent 240 of FIG. 2 in order to manage the distributed database 230. Accordingly, the method 300 of FIG. 3 will now be described with frequent reference to the environment 200 of FIG. 2.

The method 300 includes evaluating a front database following a data distribution policy to determine one or more front database segments that are to be moved to one or more cloud databases (act 311). For instance, in FIG. 2, the data movement agent 240 evaluates the policy 252 to determine or more segments of the front database(s) 211 that are to be moved to the remote cloud database(s) 221. For instance, the segments being moved might include one or more rows of a front database, one or more columns of a front database, or one or more cells of the front database. Upon identifying the front database segment(s) to be moved (act 311), the identified front database segments are then caused to move to the remote cloud database 221 (act 312). For instance, the data movement agent 240 may cause the identified front database segment(s) to be moved from the front database(s) 211 to the remote cloud database(s) 221.

In one embodiment, security may be accomplished by encrypting at least some content of front database segments prior to moving the front database segments to the remote cloud database. However, to allow at least some computation to be performed remotely in the cloud (e.g., by the query plan processor 222), some fields may remain in the clear. The front system may thus retain control over the encryption key (e.g., in the query plan generator 212), and provide securely encrypted content into the remote cloud database.

For instance, suppose that a certain table has a list of employees. There is a column for each of name, salary, social security number, title, hire date, and so forth. In the segments that are in the front database(s) 211, all of the data may be in the clear. However, in the segments that are in the remote cloud database(s) 221, some of these columns may be encrypted (such as name and social security number), while allowing other columns (e.g., salary, title, hire date) to be in the clear. Accordingly, if there was a query that asked for the social security number of all employees having a salary greater than $200,000, the query could be remotely processed by the query plan processor 222 (e.g., using the salary information as input in the clear). However, rather than return the social security numbers directly, the query plan processor 222 would return the encrypted versions of the social security numbers. The frontal system 210 has the decryption key, and thus the frontal system is able to acquire the sensitive social security number information.

Returning to FIG. 3, the method 300 also includes evaluating a remote cloud database following a data distribution policy to determine one or more remote cloud database segments that are to be moved to one or more front databases (act 321). For instance, in FIG. 2, the data movement agent 240 evaluates the policy 251 to determine one or more segments of the remote cloud database(s) 211 that are to be moved to the front database(s) 211. For instance, the segments being moved might include one or more rows of a remote cloud database, one or more columns of a remote cloud database, or one or more cells of the remote cloud database. Upon identifying the remote cloud database segment(s) to be moved (act 321), the identified remote cloud database segments are then caused to move to the front database(s) (act 322). For instance, the data movement agent 240 may cause the identified remote cloud database segment(s) to be moved from the remote cloud database(s) 221 to the frontal database(s) 211. When moving database segment(s) from the remote cloud database(s) 221 to the front database(s) 211, any encrypted content may be decrypted for representation on the front database(s) 211.

When there is a movement of database segments to or from the front database(s) 211 (e.g., act 311 or act 321), the location data available to the query plan generator is updated to reflect completion of the movement of the database segments (act 331). For instance, with reference to FIG. 2, when the data movement agent 240 moves database segments from the front database(s) 211 to the remote cloud database(s) 221 (as represented by the arrow 242), or from the remote cloud database(s) 221 to the front database(s) 211 (as represented by arrow 241), the location data 213 is updated (as represented by arrow 243). For instance, the movement (act 311 or act 321) and the location update (act 331) might occur atomic ally.

The movement of data represented by arrows 241 and 242 may be low volume compared to the size of the front database(s) 211, and especially compared to the remote database(s) 220. Accordingly, the arrows 241 and 242 might represent thus a trickle of information going back and forth, to ensure that the proper distribution (defined by policies 251 and 252) is achieved at any given time, and over time.

As previously mentioned, the decision on whether or not to move data between the front database(s) 211 and the remote database(s) 221 is made in accordance with a data distribution policy. The data distribution policy 252 governing movement of front database segment(s) to the remote cloud database(s) 221 need not be the same as the data distribution policy 251 governing movement of remote database segment(s) to the front database(s) 211. For instance, in one example, the data distribution policy 251 for moving remote cloud database segment(s) into front database(s) 211 might be an on-demand policy, where they are moved when a query calls for them. Alternatively or in addition, the data distribution policy 252 for moving front database segment(s) into the remote cloud database(s) 221 might be in accordance with an assessment that the front database segment(s) are not as likely to be used to respond to a query in the near future.

However, either or both of the data distribution policies 251 and 252 might be in accordance with an on demand policy, in which database segments are moved as needed in the different databases. For instance, when the command system 114 issues a command that requires access to a particular remote database segment, the data movement agent 240 may move that remote database segment to the front database(s) 211.

Alternatively or in addition, either or both of the data distribution policies 251 and 252 might be in accordance with a policy that is specified by the user. For instance, the user of the database utilization system 214 might issue a command that represents a predicate that defines a data distribution policy. For instance, consider a distributed database of sales information that includes a column for sales date. The user might specify a predicate dictating that sales records that have a sales data greater than one year old are to be moved to the cloud database(s).

Alternatively or in addition, either or both of the data distribution policies 251 and 252 might be in accordance with a historical and or anticipated frequency of usage of the data. Sometimes, the frequency of usage (historical or anticipated) is referred to as “temperature” of the data. The principles described herein are not limited to any particular way of determining the temperature of the data. In one embodiment, the hotter (or more frequently accessed) database segments are moved to the front database(s).

Alternatively or in addition, either or both of the data distribution policies 251 and 252 might be in accordance with a subject domain. For instance, in some conditions and times, it might be more beneficial to have database segments associated with one domain, than another.

Alternatively or in addition, either or both of the data distribution policies 251 and 252 might be in accordance with time of data creation. For instance, one example database might simply gather events data, where each table includes a list of events that occurred in a given month. Tables that include events from more distant months may be removed from the front database(s) to the remote database(s).

Alternatively or in addition, either or both of the data distribution policies 251 and 252 might be based on temporal versioning (e.g., might be based on temporal settings of the database table), in which one, some or all prior versions of data are to be located in the remote cloud database(s).

Alternatively or in addition, either or both of the data distribution policies 251 and 252 might be based on workflow status of workflows that use the data. Alternatively or in addition, either or both of the data distribution policies 251 and 252 might be based on total cost of ownership for keeping data in the front database(s) versus the remote cloud database(s).

Alternatively or in addition, either or both of the data distribution policies 251 and 252 might be based on a list of data that is excluded from being remoted to the cloud database. Such exclusion might be based on security or regulatory requirements. Furthermore, the policy might indicate that such information might be remoted into the cloud database(s) only if encrypted. Accordingly, the policies 251 and 252 might be used not only to identify which database segments to move, but also what fields should be encrypted prior to movement into the cloud database.

FIG. 4 illustrates an example backup environment 400 in which a distributed database may be backed up. The backup environment 400 may be used to back up the distributed database 230 of FIG. 2. As represented by the backup environment, the backup includes the front database(s) 401 (e.g., the front database(s) 211 of FIG. 2) as those front database(s) exist or existed at the time of the backup. Accordingly, in order to perform a backup of the database 230, at least the front database(s) is/are backed up.

However, to represent the remote database(s), rather than backup the entirety of the remote database(s), restore information 412 for the remote database(s) 221 is stored. Such restore information 412 is sufficient to be able to restore the state of the remote cloud database(s) (e.g., remote cloud database(s) 221) as of the backup time. For instance, such restore information 412 might point to the remote cloud database(s) 221 and perhaps provide enough information such that the remote database(s)′ state as of backup time is ascertained. In some cloud embodiments, the remote cloud system 220 itself maintains backups and replicas of the remote cloud database(s) 221. This is a conventional service offered by current clouds. Each row in the remote cloud database(s) 221 may have a timestamp associated with them which represents when the state of the row last changed. If the restore was to happen to, for instance, Oct. 1, 2014 at 1 pm, then restoration would delete all rows with a timestamp prior to Oct. 1, 2014 at 1 pm. In that case, the restore information 412 might include the wall clock time to be restored to. The timestamp may be a literal time-of-day (or “wall clock time”), but might also be a more generic application time (e.g., counter, identified, number) representing row version information (such as would be used in a temporal database or a multi-version database system. Accordingly, during restoration, the remote cloud database(s) 221 are also restored to the appropriate backup time.

Accordingly, a distributed database technology has been described in which the distribution of database segments between the front database(s) and the remote database(s) may change over time in response to policy. Furthermore, the distributed nature of the database need not be apparent to the issuer of the query, and the consumer of the query results. Furthermore, partial computation of the query may be moved to the cloud system. Thus, storage and processing resources may be moved to the cloud, thereby taking advantage of efficiencies in storage and processing that are offered by the cloud.

Claim Support Section

Herein described is a method for maintaining a database that is distributed across a front databases and one or more cloud databases. The method includes an act of evaluating a front database following a data distribution policy to determine one or more front database segments that are to be moved to one or more cloud databases. Furthermore, in response to the act of evaluating the front database, the one or more front database segments are caused to be moved to at least one of the one or more cloud databases. The remote portion of the database in the one or more cloud databases is evaluated following a data distribution policy to determine one or more remote database segments that are to be moved from at least one of the one or more cloud databases to the front database. Furthermore, in response to the act of evaluating the remote portion of the database, the one or more remote database segments are caused to be moved to the front database.

The method may further include an act of backing up the database, the act of backing up the database comprising: an act of backing up the front database; and an act of backing up remote restore information sufficient to acquire a state of at least one of the one or more cloud databases as of a backup time corresponding to the act of backing up the front database.

The one or more cloud databases may comprise a single cloud database, or a plurality of cloud databases. Furthermore, the one or more front database segments may each comprising one or more rows of the front database, one or more columns of the front database, or a combination.

The data distribution policy may be specified by a user, based on frequency of data usage, being based on temporal versioning, based on subject domain, based on time population time, based on workflow status, based on total cost of ownership, and/or include an on demand policy.

Also herein described is a computer program product comprising one or more computer-readable storage media having thereon computer-executable instructions that are structured such that, when executed by one or more processors of a computing system, cause the computing system to perform a method for maintaining a database that is distributed across a front database and one or more cloud databases. Here, the method may comprise an act of evaluating database segments following a data distribution policy to identify one or more database segments that are to be transferred to or from the one or more cloud databases from or to the front database; and in response to the act of evaluating the database segments, an act of causing the identified one or more database segments to be correspondingly moved. The act of identifying one or more database segments to be correspondingly moved may comprise atomically performing the following: an act of correspondingly moving the identified one or more database segments; and an act of updating location data available to a query plan generator to reflect completion of the act of corresponding moving the identified database segments.

Also herein described is a computing system comprising: one or more processors; and one of more computer-readable storage media having thereon computer-executable instructions that are structured such that, when executed by the one or more processors, causes the computing system to instantiate and/or operate the following: a data movement manager configured to evaluating database segments following a data distribution policy to identify one or more database segments that are to be transferred to or from the one or more cloud databases from or to a front database; and in response to the act of evaluating the front database, an act of causing the identified one or more database segments to be correspondingly moved.

The one or more computer-readable storage media may further have thereon computer-executable instructions that are structured such that, when executed by the one or more processors cause the computing system to instantiate and/or operate the following: a query plan generator that receive queries directed towards a database that comprises both the front database and the one or more cloud databases, and is configured to use location data to formulate a corresponding query plan that is executed against the front database and the one or more cloud databases.

The data movement manager may be configured to atomically perform the following: the act of causing the identified one or more database segments to be correspondingly moved; and an act of updating the location data available to the query plan generator to reflect completion of the act of causing the identified one or more database segments to be correspondingly moved.

The query plan generator may be configured abstain from causing the corresponding query to be executed against at least one of the one or more cloud databases under at least some circumstances in which the location data indicates that responsive information is on the at least one of the one or more cloud databases.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for maintaining a database that is distributed across a front databases and one or more cloud databases, the method comprising:
an act of evaluating a front database following a data distribution policy to determine one or more front database segments that are to be moved to one or more cloud databases;
in response to the act of evaluating the front database, an act of causing the one or more front database segments to be moved to at least one of the one or more cloud databases;
an act of evaluating a remote portion of the database in the one or more cloud databases following a data distribution policy to determine one or more remote database segments that are to be moved from at least one of the one or more cloud databases to the front database; and
in response to the act of evaluating the remote portion of the database, an act of causing the one or more remote database segments to be moved to the front database.

2. The method in accordance with claim 1, further comprising an act of backing up the database, the act of backing up the database comprising:
an act of backing up the front database; and
an act of backing up remote restore information sufficient to acquire a state of at least one of the one or more cloud databases as of a backup time corresponding to the act of backing up the front database.

3. The method in accordance with claim 1, the one or more cloud databases comprising a single cloud database.

4. The method in accordance with claim 1, the one or more cloud databases comprising a plurality of cloud databases.

5. The method in accordance with claim 1, the one or more front database segments each comprising one or more rows of the front database.

6. The method in accordance with claim 1, the one or more front database segments each comprising one or more columns of the front database.

7. The method in accordance with claim 1, the data distribution policy being specified by a user.

8. The method in accordance with claim 1, the data distribution policy being based on frequency of data usage.

9. The method in accordance with claim 1, the data distribution policy being based on temporal versioning.

10. The method in accordance with claim 1, the data distribution policy being based on subject domain.

11. The method in accordance with claim 1, the data distribution policy being based on population time.

12. The method in accordance with claim 1, the data distribution policy being based on workflow status.

13. The method in accordance with claim 1, the data distribution policy being based on total cost of ownership.

14. The method in accordance with claim 1, the data distribution policy including an on demand policy.

15. A computer program product comprising one or more computer-readable storage media having thereon computer-executable instructions that are structured such that, when executed by one or more processors of a computing system, cause the computing system to perform a method for maintaining a database that is distributed across a front database and one or more cloud databases, the method comprising:
an act of evaluating database segments following a data distribution policy to identify one or more database segments that are to be transferred to or from the one or more cloud databases from or to the front database; and
in response to the act of evaluating the database segments, an act of causing the identified one or more database segments to be correspondingly moved.

16. The computer program product in accordance with claim 15, the act of identifying one or more database segments to be correspondingly moved comprising atomically performing the following:
an act of correspondingly moving the identified one or more database segments; and
an act of updating location data available to a query plan generator to reflect completion of the act of corresponding moving the identified database segments.

17. A computing system comprising:
one or more processors;
one of more computer-readable storage media having thereon computer-executable instructions that are structured such that, when executed by the one or more processors, causes the computing system to instantiate and/or operate the following:
a data movement manager configured to evaluating database segments following a data distribution policy to identify one or more database segments that are to be transferred to or from the one or more cloud databases from or to a front database; and in response to the act of evaluating the front database, an act of causing the identified one or more database segments to be correspondingly moved.

18. The system in accordance with claim 17, the one or more computer-readable storage media further having thereon computer-executable instructions that are structured such that, when executed by the one or more processors causes the computing system to instantiate and/or operate the following:
a query plan generator that receive queries directed towards a database that comprises both the front database and the one or more cloud databases, and is configured to use location data to formulate a corresponding query plan that is executed against the front database and the one or more cloud databases.

19. The system in accordance with claim 18, the data movement manager configured to atomically perform the following:
the act of causing the identified one or more database segments to be correspondingly moved; and
an act of updating the location data available to the query plan generator to reflect completion of the act of causing the identified one or more database segments to be correspondingly moved.

20. The system in accordance with claim 18, the query plan generator configured abstain from causes the corresponding query to be executed against at least one of the one or more cloud databases under at least some circumstances in which the location data indicates that responsive information is on the at least one of the one or more cloud databases.
